(19) United States
(12) Patent Application Publication
(10) Pub. No.: US 2025/0304079 A1
(43) Pub. Date: Oct. 2, 2025

(54) DEVICE AND METHOD FOR EVALUATING SENSOR DATA OF A SENSOR DEVICE AND DRIVER ASSISTANCE SYSTEM

(71) Applicant: Robert Bosch GmbH, Stuttgart (DE)

(72) Inventors: Alexander Bartler, Villingen-Schwenningen (DE); Anne Reimann, Filderstadt (DE); Csaba Domokos, Simmozheim (DE); Jiaying Lin, Magstadt (DE); Kilian Rambach, Stuttgart (DE); Marcel Schreiber, Neu-Ulm (DE); Maurice Quach, Ditzingen (DE); Michael Ulrich, Stuttgart (DE); Ruediger Jordan, Stuttgart (DE); Yuri Feldman, Haifa (IL)

(21) Appl. No.: 19/068,077

(22) Filed: Mar. 3, 2025

(30) Foreign Application Priority Data
Mar. 26, 2024 (DE) 10 2024 202 858.4

(51) Int. Cl. B60W 50/00

(52) U.S. Cl. CPC B60W 50/00; B60W 2420/403; B60W 2420/408

(57) ABSTRACT

A device for evaluating sensor data of a sensor device. The device includes an interface that receives the sensor data from the sensor device. A computing device provides input data to an artificial neural network based on the received sensor data and the artificial neural network uses the input data to output output data for evaluating the sensor data. The computing device adjusts parameters of the artificial neural network using a memory state, wherein the memory state depends on latent features of the artificial neural network relating to a previous calculation step.

### CROSS REFERENCE

The present application claims the benefit under 35 U.S.C. § 119 of German Patent Application No. DE 10 2024 202 858.4 filed on Mar. 26, 2024, which is expressly incorporated herein by reference in its entirety.

### FIELD

The present invention relates to a device and a method for evaluating sensor data of a sensor device and to a driver assistance system.

### BACKGROUND INFORMATION

Driver assistance systems and autonomous driving require an accurate representation of the surroundings of the motor vehicle. Radar sensors are used for this purpose, in addition to camera and LiDAR sensors, because radar is more reliable under a variety of weather conditions and enables direct speed measurement.

After the raw data are processed, the radar data can be presented as a point cloud. A radar point corresponds to a three-dimensional location and to other characteristics, for example the radar cross-section or the measured Doppler speed. These radar points can be used as input for an artificial neural network, which outputs minimum surrounding rectangles (so-called bounding boxes) to describe the position and the shape of objects and a classification, for example.

Ulrich et al., “Improved orientation estimation and detection with hybrid object detection networks for automotive radar,” in 2022 IEEE 25th International Conference on Intelligent Transportation Systems (ITSC), pp. 111-117, 2022, for instance, describes a grid-based object detection network. The radar point cloud is first projected into a grid in the bird's eye view, and then processed in a neural network like an image.

### SUMMARY

The present invention provides a device and method for evaluating sensor data of a sensor device, as well as a driver assistance system.

Preferred example embodiments of the present invention are disclosed herein.

According to a first aspect, the present invention relates to a device for evaluating sensor data of a sensor device. According to an example embodiment of the present invention, an interface receives the sensor data from the sensor device. A computing device provides input data to an artificial neural network based on the received sensor data and the artificial neural network uses the input data to output output data for evaluating the sensor data. The computing device adjusts parameters of the artificial neural network using a memory state, wherein the memory state depends on latent features of the artificial neural network relating to a previous calculation step.

According to a second aspect, the present invention relates to a driver assistance system comprising a device for evaluating sensor data of a sensor device according to the first aspect of the present invention.

According to a third aspect, the present invention relates to a method for evaluating sensor data of a sensor device. According to an example embodiment of the present invention, sensor data are generated by the sensor device. Input data for an artificial neural network are provided based on the received sensor data. Output data are output by the artificial neural network based on the input data for evaluating the sensor data. Parameters of the artificial neural network are adjusted using a memory state, wherein the memory state depends on latent features of the artificial neural network relating to a previous calculation step.

The use of a memory state in the neural network makes it possible to store temporal information and take it into account in the current calculation step. For this purpose, it is not necessary to temporarily store and process the measurements of multiple time steps; instead it is possible to store only the latent features, which significantly reduces the memory requirement and the computing requirement.

The parameters adjusted by the computing device can in particular include latent features of the artificial neural network.

Latent features refer to elements of a latent space, wherein objects that are similar to one another are close to one another. Such latent features are generated by the neural network in a calculation and can then be used in later steps.

According to an example embodiment of the present invention, the information from multiple time steps is stored based on latent features and not at the network input. This allows the fusion of multiple time steps to be carried out in every step, instead of just using a long history of raw data for each prediction. This has the advantage that the artificial neural network learns which information should be kept in the memory state.

The memory requirement and the inference time do not depend on the size of the history. The processing time and the memory requirement are incurred only during the training process of the artificial neural network, but not during the use of the artificial neural network.

According to one example embodiment of the device of the present invention for evaluating sensor data of the sensor device, the computing device concatenates latent features of the artificial neural network (as parameters) with the latent features of the memory state.

According to one example embodiment of the device of the present invention for evaluating sensor data of the sensor device, the latent features include location coordinates with feature vectors. These can then be linked to one another, for example by means of concatenation.

According to one example embodiment of the device of the present invention for evaluating sensor data of the sensor device, the computing device at least partially compensates a movement of the ego vehicle (in which the sensor device is mounted). This makes it possible to improve the output data of the artificial neural network.

According to one example embodiment of the device of the present invention for evaluating sensor data of the sensor device, the computing device transforms the memory state as a function of a movement of the ego vehicle. The compensation of the movement of the ego vehicle can thus take place at the level of the memory states.

According to one example embodiment of the device of the present invention for evaluating sensor data of the sensor device, the artificial neural network comprises at least one layer for compensating the movements of the ego vehicle.

According to one example embodiment of the device of the present invention for evaluating sensor data of the sensor device, the sensor device comprises at least one radar sensor, at least one LiDAR sensor and/or at least one camera sensor. The sensor device can also comprise an ultrasonic sensor, a movement sensor and/or a thermal imaging sensor.

According to one example embodiment of the device of the present invention for evaluating sensor data of the sensor device, the input data of the artificial neural network include grid-based and/or point-based data. In particular certain events can be included in grid segments or at points.

According to one example embodiment of the device of the present invention for evaluating sensor data of the sensor device, the grid-based data are provided in a grid in a bird's eye view. This representation is advantageous in particular for driver assistance systems.

According to one example embodiment of the device of the present invention for evaluating sensor data of the sensor device, the input data of the artificial neural network include point clouds and/or spectral data. The reduced inference time that results from using the memory state is particularly advantageous in particular for dense point clouds.

According to one embodiment of the device of the present invention for evaluating sensor data of the sensor device, the computing device generates the input data of the artificial neural network based only on sensor data of a current acquisition step (or acquisition time) of the sensor device. The evaluation can therefore be carried out more quickly than with alternative approaches in which the measurements of multiple time steps are aggregated. In particular the accumulation of data at the network input is not very efficient, in particular in the case of larger point clouds and a long history.

The use of sensor data from only the current acquisition step makes it possible to minimize the processing time and reduce the memory requirements. It can also prevent multiple measurements from different time steps being placed within the same grid cell.

According to one example embodiment of the device of the present invention for evaluating sensor data of the sensor device, the output data of the artificial neural network include minimum surrounding rectangles and/or an object class.

According to one example embodiment of the device of the present invention for evaluating sensor data of the sensor device, the computing device uses the output data of the artificial neural network to carry out at least one of occupancy grid generation, object detection, object tracking, semantic segmentation of the sensor data, anomaly detection, regression analysis and generation of a control signal.

Further advantages, features, and details of the present invention will emerge from the following description, in which different embodiment examples of the present invention are described in detail with reference to the figures.

### BRIEF DESCRIPTION OF THE DRAWINGS

FIG. 1 shows a schematic block diagram of a driver assistance system comprising a device for evaluating sensor data of a sensor device according to one example embodiment of the present invention.

FIG. 2 shows schematic illustrations of a neural network at two different calculation steps, according to an example embodiment of the present invention.

FIG. 3 shows a flow chart of a method for evaluating sensor data of a sensor device according to one example embodiment of the present invention.

The numbering of method steps is for the sake of clarity and is generally not intended to imply a specific chronological order. It is in particular also possible to carry out multiple method steps at the same time.

### DETAILED DESCRIPTION OF EXAMPLE EMBODIMENTS

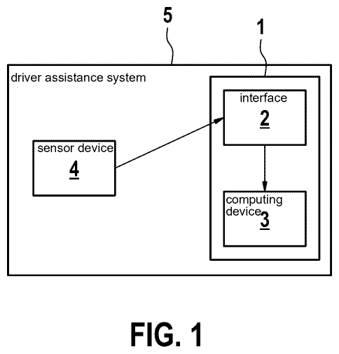

FIG. 1 shows a schematic block diagram of a driver assistance system 5 or autonomous driving system for a motor vehicle.

However, the present invention is not limited to devices in motor vehicles. Other possible applications include radar sensors that use object information, such as stationary radar sensors for traffic monitoring or radar sensors for bicycles or other vehicles. They can also be used in the field of robotics, for example for obstacle detection systems of autonomous lawnmowers or the like.

A device 1 for evaluating sensor data of a sensor device 4 comprises an interface 2 that receives the sensor data from the sensor device 4. The sensor device 4 can, for instance, comprise at least one radar sensor, at least one LiDAR sensor and/or at least one camera sensor. The interface 2 can be coupled to the sensor device 4 via a wired or wireless connection.

A computing device 3 provides input data to an artificial neural network based on the received sensor data and the artificial neural network uses the input data to output output data for evaluating the sensor data. For this purpose, the computing device 3 can comprise at least one processor, microprocessor, application-specific integrated circuit (ASIC) or the like.

The computing device 3 adjusts parameters of the artificial neural network using a memory state, wherein the memory state depends on latent features of the artificial neural network relating to a previous calculation step.

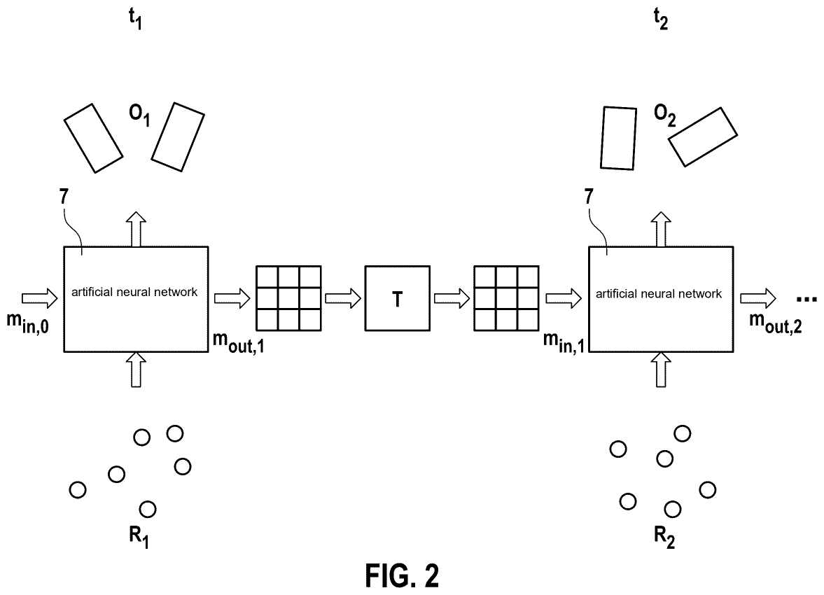

FIG. 2 shows schematic illustrations of an artificial neural network 7 at two different calculation steps t₁ and t₂. The neural network 7 receives input data R₁ or R₂, as well as a memory state m. The input data R₁, R₂ of the artificial neural network 7 can include grid-based and/or point-based data. Grid-based data can be provided in a grid in a bird's eye view, for instance. The input data R₁, R₂ of the artificial neural network 7 can include point clouds and/or spectral data.

The input data R₁, R₂ of the artificial neural network 7 are preferably generated based only on sensor data of a current acquisition step (or acquisition time) of the sensor device 4. There is therefore no need to combine different sensor data relating to different acquisition times.

The initial memory state m_{in,0} is set to predetermined values, for example to a zero vector, a zero matrix, or a zero tensor. The neural network 7 uses the input data R₁ to generate corresponding output data O₁. The output data O₁ of the artificial neural network 7 can include minimum surrounding rectangles, for example. Additionally or alternatively, the output data O₁ can include an object class.

The artificial neural network 7 can be configured as a convolutional neural network (CNN) with a large number of layers that each process input data from a previous layer and output output data.

Latent features of the artificial neural network 7 relating to the first calculation step t₁ are stored as a first memory state m_{out,1}. This is followed by a transformation T, which is applied to the first memory state m_{out,1} and has the result m_{in,1}. This transformation at least partially compensates a movement of the ego vehicle.

The movement of the ego vehicle can be known from sensor data of the motor vehicle or from other information, for example from sensor data of acceleration sensors, rotation rate sensors and speed sensors or from GPS data.

In a grid-based method, the grid can be transformed as a function of the movement of the ego vehicle or the points can be accordingly transformed within the grid. The transformation can in particular include a rotation and a translation.

Additionally or alternatively, the artificial neural network 7 can comprise at least one layer for compensating the movements of the ego vehicle.

The first memory state m_{in,1} after the transformation is provided to the artificial neural network 7 at the second calculation step t₂. The latent features of the artificial neural network 7 relating to the second calculation step t₂ can be linked to the stored latent features of the memory state m_{in,1}, for example by means of concatenation.

The latent features can, for instance, include two-dimensional or three-dimensional location coordinates with associated feature vectors. According to one embodiment, the latent features of the memory state include all of the feature vectors of a given layer. Feature vectors of a plurality of given layers can be stored as latent features as well.

Latent features of the neural network relating to the second calculation step t₂ are stored as a second memory state m_{out,2} and can be used for a further (not depicted) third calculation step to adjust parameters of the artificial neural network.

The computing device 3 can optionally use the output data O₁, O₂ of the artificial neural network 7 to carry out occupancy grid generation, object detection, object tracking, semantic segmentation of the sensor data, anomaly detection, regression analysis and/or generation of a control signal.

The semantic segmentation of the sensor data can be carried out with reference to traffic signs, road surfaces, pedestrians or vehicles, for example. This is done on the basis of low-level features, e.g. edges or pixel attributes in images.

The output data O₁, O₂ can be used to generate one or more continuous values, for example to carry out a regression analysis, e.g. in relation to a distance, a speed, an acceleration or the tracking of an element, e.g. an object.

FIG. 2 shows the artificial neural network for only two time steps. However, the described processing can be repeated accordingly for each new time step. The memory state can thus potentially store information over a long period of time.

The present invention is not limited to radar points as input data. For example, LiDAR point clouds can be used as input data of the artificial neural network instead of radar points. Radar spectral data could furthermore also be used as input data. The use of other sensor data is possible as well.

The present invention can also be used for non-grid-based features, for example in point-based methods. For this purpose, the memory state can include a set of points x, y, z with a respective feature vector as latent features, for instance. It is again possible to insert a transformation T, which carries out an ego-motion compensation, i.e. an adjustment of the x, y, z values based on the difference in the poses of the ego vehicle between the two time steps t₁ and t₂.

The fusion of the latent features in the memory state with the latent features of the current time step can be carried out with nearest neighbor association and processing in a network layer in order to fuse the feature vectors of the associated points.

The transformation to compensate the ego-motion can also be extended to several network layers of the artificial neural network.

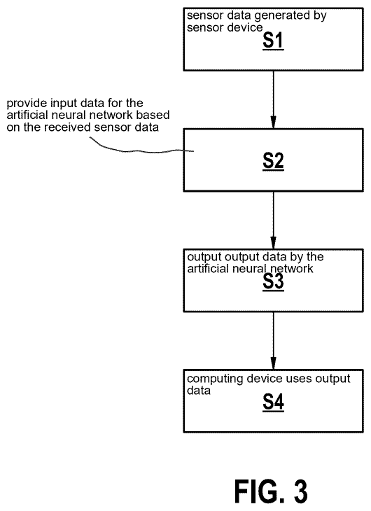

FIG. 3 shows a flow chart of a method for evaluating sensor data of a sensor device, such as a radar sensor, a LiDAR sensor and/or a camera sensor.

In a step S1, sensor data are generated by the sensor device 4.

In a step S2, input data R₁, R₂ are provided for an artificial neural network 7 based on the received sensor data. The artificial neural network 7 can be stored and executed on a computing device 3.

The input data R₁, R₂ of the artificial neural network 7 are preferably generated based only on sensor data of a current acquisition step of the sensor device 4. The input data R₁, R₂ of the artificial neural network 7 can include grid-based and/or point-based data.

The grid-based data can be provided in a grid in a bird's eye view, for example. The input data R₁, R₂ of the artificial neural network 7 can include point clouds and/or spectral data.

In a step S3, output data O₁, O₂ are output by the artificial neural network 7 based on the input data R₁, R₂ for evaluating the sensor data. The output data O₁, O₂ of the artificial neural network 7 include minimum surrounding rectangles that specify the location and shape of the objects, for instance. Additionally or alternatively, an object class can be specified.

Parameters of the artificial neural network 7 are adjusted using a memory state m, wherein the memory state m depends on latent features of the artificial neural network 7 relating to a previous calculation step. The latent features can, for instance, include location coordinates with feature vectors.

For this purpose, the computing device 3 can concatenate latent features of the artificial neural network 7 with the latent features of the memory state.

It can optionally be provided that the computing device 3 at least partially compensates a movement of the ego vehicle. For this purpose, the computing device 3 can adjust the memory state as a function of a movement of the ego vehicle. Alternatively or additionally, the artificial neural network 7 can comprise at least one layer for compensating the movements of the ego vehicle.

In a step S4, the computing device 3 uses the output data O₁, O₂ of the artificial neural network 7 to carry out at least one of occupancy grid generation, object detection, object tracking, semantic segmentation of the sensor data, anomaly detection, regression analysis and/or generation of a control signal.

For example, an occupancy grid can be estimated with speed estimates using radar locations as input. The artificial neural network can also be used to predict a semantic segmentation of the input data or to predict the scene flow, i.e. to determine a displacement vector or a speed for each location.

In a tracking method, the memory state can be considered as prior information, that is then combined with the current measurements. To obtain consistent tracking identifications over time, predicted bounding boxes can be compared with bounding boxes from the last time step. Compared to single-shot object detection methods that use only the measurements of the current time step, the use of the memory state makes it possible to achieve temporally consistent predictions, so that a simple assignment of the bounding boxes can be sufficient.

What is claimed is:

1. A device for evaluating sensor data of a sensor device, comprising:
an interface configured to receive the sensor data from the sensor device; and
a computing device configured to provide input data to an artificial neural network based on the received sensor data, and the artificial neural network uses the input data to output output data for evaluating the sensor data;
wherein the computing device is configured to adjust parameters of the artificial neural network using a memory state, wherein the memory state depends on latent features of the artificial neural network relating to a previous calculation step.

2. The device according to claim 1, wherein the computing device is configured to concatenate latent features of the artificial neural network with the latent features of the memory state.

3. The device according to claim 1, wherein the latent features include location coordinates with feature vectors.

4. The device according to claim 1, wherein the computing device is further configured to at least partially compensate a movement of an ego vehicle.

5. The device according to claim 4, wherein the computing device is configured to transform the memory state as a function of a movement of the ego vehicle.

6. The device according to claim 4, wherein the artificial neural network includes at least one layer for compensating movements of the ego vehicle.

7. The device according to claim 1, wherein the sensor device includes at least one of: a radar sensor, LiDAR sensor, and camera sensor.

8. The device according to claim 1, wherein the computing device is configured to generate the input data of the artificial neural network based on sensor data only of a current acquisition step of the sensor device.

9. A driver assistance system, comprising:
a device configured to evaluate sensor data of a sensor device of a motor vehicle, the device including:
an interface configured to receive the sensor data from the sensor device, and
a computing device configured to provide input data to an artificial neural network based on the received sensor data, and the artificial neural network uses the input data to output output data for evaluating the sensor data,
wherein the computing device is configured to adjust parameters of the artificial neural network using a memory state, wherein the memory state depends on latent features of the artificial neural network relating to a previous calculation step.

10. A method for evaluating sensor data of a sensor device, comprising the following steps:
generating sensor data using the sensor device;
providing input data for an artificial neural network based on the sensor data; and
outputting output data by the artificial neural network based on the input data for evaluating the sensor data;
wherein parameters of the artificial neural network are adjusted using a memory state, wherein the memory state depends on latent features of the artificial neural network relating to a previous calculation step.
